(19) United States
(12) Patent Application Publication
(10) Pub. No.: US 2003/0131897 A1
(43) Pub. Date: Jul. 17, 2003

(54) Bifurcated duct for a vehicle induction system

(75) Inventor: Mark Letourneau, Dover Centre (CA)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive, Inc.

(21) Appl. No.: 10/315,414

(22) Filed: Dec. 9, 2002

Related U.S. Application Data
(60) Provisional application No. 60/348,469, filed on Jan. 14, 2002.

(51) Int. Cl. F15D 1/00

(52) U.S. Cl. 138/39

(57) ABSTRACT

A fluid communication conduit 18 for a vehicle induction system includes a vane 28 offset from a center axis to generally bifurcate the duct 20. The vane 28 assures generally equal airflow distribution to separate plenum portions to maintain engine performance. The vane 28 is separated into a plurality of interrupted vane portions 40, 42 each having aerodynamic end section profiles 40e, 42e to minimize turbulent airflow.

### BACKGROUND OF THE INVENTION

The present application claims priority to U.S. Provisional Patent Application Serial No. 60/348,469, filed Jan. 14, 2002.

The present invention relates to a vehicle induction system, and more particularly to a conduit having an offset vane.

Air ducts of various lengths and sizes are used to transfer clean, filtered air from an air filter through an engine air intake system. Air ducts are also utilized to transfer cooled or heated air from within the engine compartment to the passenger compartment of an automobile.

Oftentimes the ducts are of a complicated serpentine configuration due to limited space within vehicle compartments. The serpentine configurations are formed through bends which may induce fluid flow difficulties which may reduce system performance. Performance considerations and consistent airflow is of particular importance to vehicle engine induction systems.

Accordingly, it is desirable to provide a vehicle fluid communication conduits which are relatively unaffected by serpentine configurations.

### SUMMARY OF THE INVENTION

The vehicle induction system according to the present invention provides a fluid communication conduit that interconnects an air cleaner and a throttle assembly. The communication conduit defines a central axis. A vane is located along a length of the fluid communication conduit offset from the axis to generally bifurcate the duct.

The vane is located adjacent angled sections of the communication conduit and offset from the center axis toward an inner arc. The vane may be separated into a plurality of interrupted vane portions each having aerodynamic end section profiles to minimize turbulent airflow.

The present invention therefore provides a vehicle fluid communication conduit which is relatively unaffected by serpentine configurations.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of a vehicle induction system;

FIG. 2 is a sectional view of a fluid communication conduit taken along a central axis;

FIG. 3 is a sectional view of a fluid communication conduit taken along line 33 of FIG. 2.

### DETAILED DESCRIPTION OF THE PREFERRED EMBODIMENT

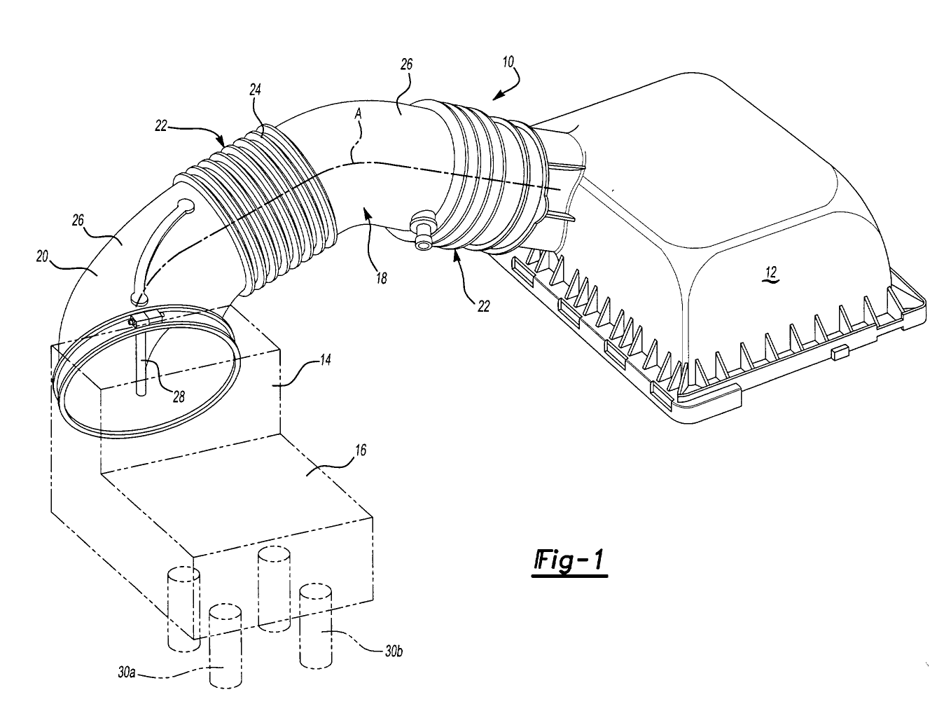

FIG. 1 illustrates a general perspective view of a vehicle induction system 10. The induction system 10 generally includes an air cleaner 12, a throttle assembly (illustrated schematically at 14) and a manifold (illustrated schematically at 16). A fluid communication conduit 18 interconnects the air cleaner 12 and the throttle assembly 14 to provide a filtered airflow communication path.

The communication conduit 18 includes a hollow duct 20 having one or more flexible sections 22 consisting of a plurality of sequentially spaced convolutions 24 and one or more angled sections or bends 26. It should be appreciated that any size, shape or configuration of hollow body may be used for transferring a fluid flow from one point to another, while still incorporating the elements of the present invention.

The fluid communication conduit 18 defines a central axis A along the length thereof. That is, axis A forms a serpentine centerline within duct 20. A vane 28 is located along a length of the fluid communication conduit 18 offset from the axis A to generally bifurcate the duct. The vane is located within the conduit to generally assure that each cylinder set 30A, 30B receives an equivalent quantity of air from the manifold 16. That is, each cylinder set 30A, 30B typically communicates with a separate throttle body portion and separate plenums of the manifold 16 to maintain consistent engine performance. As the fluid communication conduit 18 is often serpentine, airflow will tend to be unequally distributed which may result in an unequal quantify of airflow to each cylinder set 30A, 30B thereby reducing performance. The vane 28 assures generally equal airflow distribution to maintain engine performance.

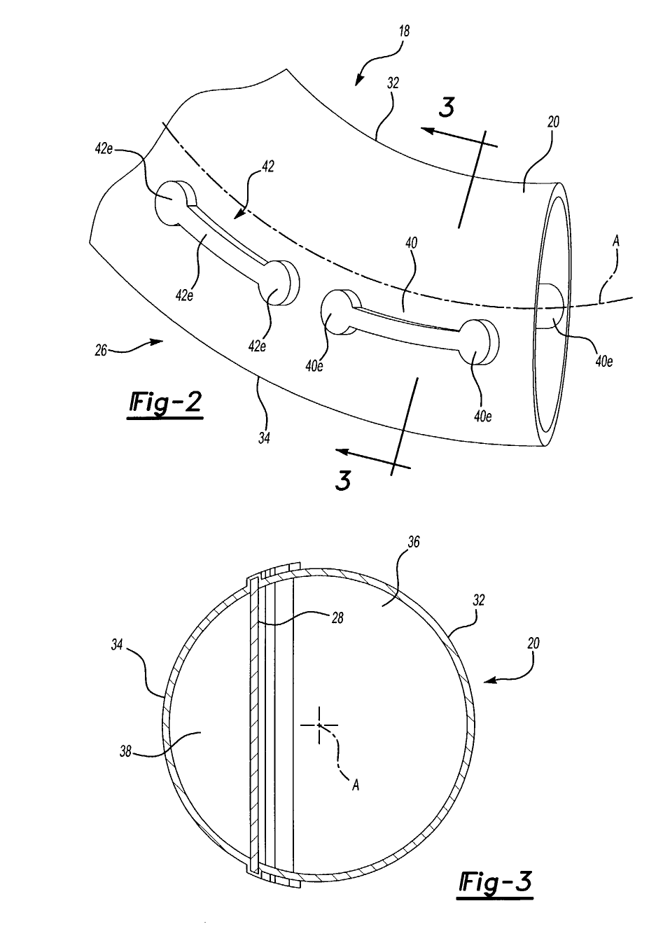

Referring to FIG. 2, an angled section 26 of the fluid communication conduit 18 is illustrated in cross section. The angled section 26 includes an inner arc 32 and an outer arc 34. The vane 28 is preferably located adjacent the angled section 26 and offset from the axis A toward the outer arc 34. The vane 28 is arranged to be substantially perpendicular to a plane which contains the angled section 26. That is, the vane 28 follows the bend.

Applicant has determined that for an approximately 90 degree bend, the vane 28 is located toward the inner arc 32 such that the fluid communication conduit 18 is divided into a first area 36 and a second area 38 (FIG. 3) in which the first area 36 is approximately 8% greater than the second area 38. Such a division has reduced the unbalanced airflow distribution to less than 1%. It should be understood that other locations for other applications will benefit from the present invention. Moreover, the vane need not necessarily be planar or span the entire duct.

The vane 28 is preferably separated into a plurality of interrupted vane portions 40, 42. The plurality of interrupted vane portions 40, 42 are located to generally follow the length of the angled section 26. Each vane portion 40, 42 includes a central segment 40c, 42c and end segments 40e, 42e. Each end segment 40e, 42e is preferably of a width greater than the width of the central segment 40c, 42c. Furthermore, each end segment 40e, 42e is preferably of an aerodynamic profile to minimize turbulent airflow. It should be understood that any number of portions, shapes, and other end profiles will benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A vehicle fluid communication conduit comprising:
a hollow duct defining a central axis; and
a vane along a length of said hollow duct, said vane offset from the central axis.

2. The vehicle fluid communication conduit as recited in claim 1, wherein said hollow duct comprises a bend comprising an inner arc and an outer arc, said vane offset toward said outer arc.

3. The vehicle fluid communication conduit as recited in claim 1, wherein said vane comprises a plurality of interrupted portions.

4. The vehicle fluid communication conduit as recited in claim 1, wherein said vane comprises an end segment of an aerodynamic profile.

5. The vehicle fluid communication conduit as recited in claim 1, wherein said vane comprises a first segment and an end segment, said end segment comprising a width greater than a width of said first segment.

6. The vehicle fluid communication conduit as recited in claim 1, wherein said vane divides said duct into a first area and a second area, said first area approximately 8% greater than said first area.

7. A vehicle fluid communication conduit comprising:
a hollow duct defining a central axis, said hollow duct comprises a bend comprising an inner arc and an outer arc; and
a vane along a length of said hollow duct, said vane offset from the central axis toward said outer arc.

8. The vehicle fluid communication conduit as recited in claim 7, wherein said vane comprises a plurality of interrupted portions.

9. The vehicle fluid communication conduit as recited in claim 7, wherein said vane comprises a first segment and an end segment, said end segment comprising a width greater than a width of said first segment.

10. A vehicle air communication conduit interconnecting an air filter and a throttle body comprising:
a hollow duct defining a central axis; and
a vane along a length of said hollow duct, said vane offset from the central axis.

11. The vehicle air communication conduit as recited in claim 10, wherein said hollow duct comprises a bend comprising an inner arc and an outer arc, said vane offset toward said outer arc.

12. The vehicle air communication conduit as recited in claim 10, wherein said vane comprises a plurality of interrupted portions.

13. The vehicle air communication conduit as recited in claim 10, wherein said vane comprises an end segment of an aerodynamic profile.

14. The vehicle air communication conduit as recited in claim 10, wherein said vane comprises a first segment and an end segment, said end segment comprising a width greater than a width of said first segment.

15. The vehicle air communication conduit as recited in claim 10, wherein said vane divides said duct into a first area and a second area, said first area approximately 8% greater than said first area.
